(19) United States
(12) Patent Application Publication
(10) Pub. No.: US 2026/0299575 A1
(43) Pub. Date: Oct. 1, 2026

(54) VISION-BASED MANUFACTURING MONITORING AND EVENT ANALYSIS

(71) Applicants: FORD MOTOR COMPANY, Dearborn, MI (US); WAYNE STATE UNIVERSITY, DETROIT, MI (US)

(72) Inventors: Elizabeth Bullard, Royal Oak, MI (US); Raj Sohmshetty, Detroit, MI (US); Yanchao Liu, Detroit, MI (US)

(21) Appl. No.: 19/573,762

(22) Filed: Mar. 20, 2026

Related U.S. Application Data
(60) Provisional application No. 63/781,507, filed on Apr. 1, 2025.

(51) Int. Cl. G05B 23/02

(52) U.S. Cl. CPC G05B 23/0267; G05B 23/0216

(57) ABSTRACT

A manufacturing monitoring system includes distributed vision units positioned at manufacturing stations to capture visual data representing station operations. Each vision unit generates time-referenced event records that include media data and contextual metadata describing observed activities. A central processing system receives and aggregates the event records to maintain an operational representation of a manufacturing line. An artificial intelligence agent analyzes the aggregated event data relative to a learned reference operating context and provides event-associated information to a user interface. In some implementations, the system associates event records with individual workpieces and may transmit control commands that interrupt operation of manufacturing equipment when observed activity departs from the reference operating context.

### CROSS-REFERENCE TO RELATED APPLICATION

This application claims the benefit of U.S. provisional application Ser. No. 63/781,507, filed Apr. 1, 2025, the disclosure of which is hereby incorporated in its entirety by reference herein.

### TECHNICAL FIELD

The present disclosure relates to manufacturing operations monitoring systems. More specifically, it pertains to an artificial intelligence (AI)-based factory operations monitoring system that provides real-time visibility, event logging, anomaly detection, and performance metrics using camera-based artificial intelligence vision systems.

### BACKGROUND

Manufacturers across multiple industries encounter obstacles when attempting to deploy real-time factory monitoring solutions, primarily due to the complexity and rigidity of conventional platforms such as Factory Information Systems (FIS), Supervisory Control and Data Acquisition (SCADA) systems, and Manufacturing Execution Systems (MES). Deployment of these platforms typically requires significant investment in programmable logic controllers (PLCs), dedicated sensors, industrial computing hardware, network infrastructure, proprietary software licenses, and specialized system integration services.

These burdens disproportionately affect small and medium-sized manufacturers (SMMs), for whom comprehensive, real-time operational visibility is often impractical or unattainable. In the absence of timely monitoring and analytics, SMMs are limited in their ability to detect production bottlenecks, optimize cycle times, or accurately identify the root causes of quality and yield issues.

In addition, traditional monitoring solutions commonly depend on specialized hardware configurations and ongoing maintenance efforts that are difficult to scale or adapt across heterogeneous production lines. As modern manufacturing environments evolve toward higher variability and shorter production cycles, manufacturers increasingly require flexible monitoring systems that can deliver actionable insights with minimal disruption to existing workflows and infrastructure.

### SUMMARY

In some implementations, a manufacturing monitoring system includes a one or more vision units positioned at respective manufacturing stations along a manufacturing line. Each vision unit includes a camera, a processor, data storage, and a communication interface. The vision units capture visual data representing operational activity occurring at the manufacturing stations. In certain implementations, the vision units perform localized processing of the captured data and generate time-referenced event records associated with observed station activity.

The generated event records may include media data and contextual metadata describing operational conditions associated with the observed activity. The event records may include, for example, timestamps, identifiers of the vision units that captured the events, and information describing operating context associated with the observed station.

A central processing system may be communicatively coupled to the vision units. The central processing system may include one or more processors and associated memory storing executable instructions. The central processing system may receive and aggregate event records generated by multiple vision units and may maintain an operational representation of the manufacturing line. In some implementations, the operational representation may include a digital representation reflecting relationships between manufacturing stations and event sequences occurring within the manufacturing process.

An artificial intelligence agent executed by the central processing system may receive event-related data derived from the event records. The artificial intelligence agent may analyze the received data relative to a learned reference operating context associated with operation of the manufacturing line. Based on this analysis, the system may generate operational information associated with observed station activity and present the information to one or more user interfaces for review or action.

In some implementations, each vision unit may establish a reference operating context for the corresponding manufacturing station during a calibration phase. During the calibration phase, the vision unit may observe representative operational activity and establish baseline information describing expected event sequences or operational characteristics associated with the station.

In certain implementations, the vision units may generate event records based on segmented operational activity identified within captured visual data. The vision units may transmit derived event data to the central processing system without continuous transmission of raw visual data, thereby reducing network bandwidth requirements.

In some implementations, the vision units may include additional sensing devices. Such sensing devices may include acoustic sensors, proximity sensors, vibration sensors, temperature sensors, thermal sensors, inertial measurement unit sensors, RADAR sensors, LIDAR sensors, or other sensing components configured to capture information associated with operation of the manufacturing station.

The central processing system may maintain an operational representation of the manufacturing line based on aggregation of event records received from multiple vision units. The operational representation may reflect station relationships, operational states, and event sequences observed across the manufacturing process.

In certain implementations, the artificial intelligence agent may include one or more trained multi-modal analytical models configured to process image data, video data, audio data, sensor data, or combinations thereof.

In some implementations, the system may associate event records with individual workpieces as the workpieces move between manufacturing stations. The central processing system may maintain a chronological process path representing the sequence of stations visited by each workpiece.

In some implementations, the central processing system may be implemented within a distributed or cloud-based computing environment.

In certain implementations, a monitoring system may include one or more vision units configured to generate time-referenced event data representing operational activity at respective manufacturing stations. A data aggregation system may receive the event data, evaluate the event data relative to a reference operating context associated with the manufacturing line, and generate station-related operational information for presentation through a user interface.

In further implementations, a manufacturing line control system may receive time-referenced event data from vision units observing manufacturing stations and compare the received event data with a stored reference operating context associated with the manufacturing line. When the received event data departs from the reference operating context, the system may transmit a halt command to equipment of the manufacturing line. The halt command may cause one or more machines, conveyors, or robotic devices within the manufacturing line to cease operation.

In certain implementations, the described architectures enable monitoring of manufacturing operations without requiring direct integration with programmable logic controllers or other station-level control systems. By using distributed vision units that observe operational activity and generate time-referenced event records representing station behavior, the system may be deployed across manufacturing environments with minimal modification to existing equipment. This architecture facilitates scalable monitoring of heterogeneous manufacturing stations while supporting event-driven analysis, traceability of workpieces across stations, and centralized operational visibility derived from aggregated event data.

### BRIEF DESCRIPTION OF THE DRAWINGS

FIG. 1 is a block diagram illustrating an artificial intelligence vision system (AVS).

FIG. 2 illustrates a representative manufacturing line including a plurality of AVS units positioned at manufacturing stations.

FIG. 3 is a flowchart illustrating operations performed during a calibration phase of the AVS.

FIG. 4 is a flowchart illustrating operations performed during a monitoring phase of the AVS.

FIG. 5 illustrates a representative event log including associated event attributes.

FIG. 6 illustrates a representative workflow executed during the monitoring phase.

FIGS. 7A and 7B are flowcharts illustrating operations performed during an event analysis phase of the AVS.

FIG. 8 illustrates a representative event report including associated report attributes.

FIG. 9 illustrates an example operating scenario processed during the event analysis phase and involving a robotic arm at a manufacturing station.

FIG. 10 illustrates a traceability operation supported by the AVS for tracking workpieces through a manufacturing process.

FIG. 11 is a high-level block diagram illustrating a representative computing device used to implement one or more functions described herein.

FIG. 12 illustrates a representative digital twin system showing aggregation of station-level event data from a plurality of manufacturing stations, maintenance of a digital twin representation in a central storage device, and presentation of role-specific operational information to different users through user interfaces.

### DETAILED DESCRIPTION

Detailed embodiments are disclosed herein. The disclosed embodiments, however, are provided as illustrative examples and may be implemented in various alternative forms. The figures are not necessarily drawn to scale, and certain features may be enlarged or reduced to better illustrate specific components or relationships. Accordingly, the structural and functional details described herein are not intended to be limiting, but instead serve as a representative framework to enable a person having ordinary skill in the art to implement the disclosed subject matter in different configurations.

The combination of artificial intelligence-based computer vision, edge computing, and cloud-based analytics presents a compelling alternative to conventional factory floor monitoring approaches. However, many existing vision-based systems lack capabilities such as autonomous calibration, contextual interpretation of out-of-pattern operating conditions, and integration with digital twin frameworks, which limits their ability to support higher-level operational intelligence.

This disclosure addresses these shortcomings by presenting a factory monitoring architecture that delivers real-time operational visibility, automated event recognition, condition deviation identification, and key performance indicator (KPI) generation through edge-deployed vision units and distributed AI agents. The architecture is designed to be self-configuring and scalable for practical deployment across manufacturing environments of varying size and complexity, including SMMs.

More specifically, this disclosure relates to monitoring a manufacturing line using an artificial intelligence vision system (AVS). The AVS operates in conjunction with multi-modal AI agents and event-driven analytics to support intelligent operation monitoring and part traceability. Through this coordinated architecture, manufacturing lines are enhanced with contextual awareness and data-driven insight for continuous visibility and traceability throughout the manufacturing workflow.

As used herein, certain terms are described for purposes of clarity and consistency. The following descriptions illustrate example meanings of selected terms used throughout this disclosure. These descriptions are not intended to limit the scope of the disclosure or the claims unless expressly stated otherwise, and the described terms may encompass additional structures, configurations, or implementations consistent with the disclosed subject matter.

A vision unit refers to a sensing device configured to capture visual data associated with operation of a manufacturing station. A vision unit may include one or more cameras, processors, memory devices, communication interfaces, and optionally additional sensors. In some implementations, the vision unit performs local processing of captured data prior to transmission to other system components.

An event record or event data refers to data representing an observed operational occurrence associated with a manufacturing station or manufacturing process. The event record or event data may include time information, identifiers, media content, metadata, sensor data, or derived analytical information associated with the observed occurrence.

A reference operating context refers to baseline information describing expected operational behavior of a manufacturing station or manufacturing line. The reference operating context may include expected event sequences, timing relationships, environmental conditions, operational states, or other contextual characteristics associated with normal operation.

An operational representation refers to a digital representation of a manufacturing process, manufacturing line, or manufacturing station derived from observed operational data. The operational representation may include graphical, structural, or data-based representations of station relationships, operational states, and event sequences.

An artificial intelligence agent refers to software or computational logic configured to analyze operational data and generate derived information, interpretations, or actions. The artificial intelligence agent may include one or more machine learning models, multi-modal models, statistical models, rule-based logic, or combinations thereof.

A halt command refers to a signal, message, instruction, or control directive transmitted to manufacturing equipment that causes modification, interruption, or cessation of operation of the equipment.

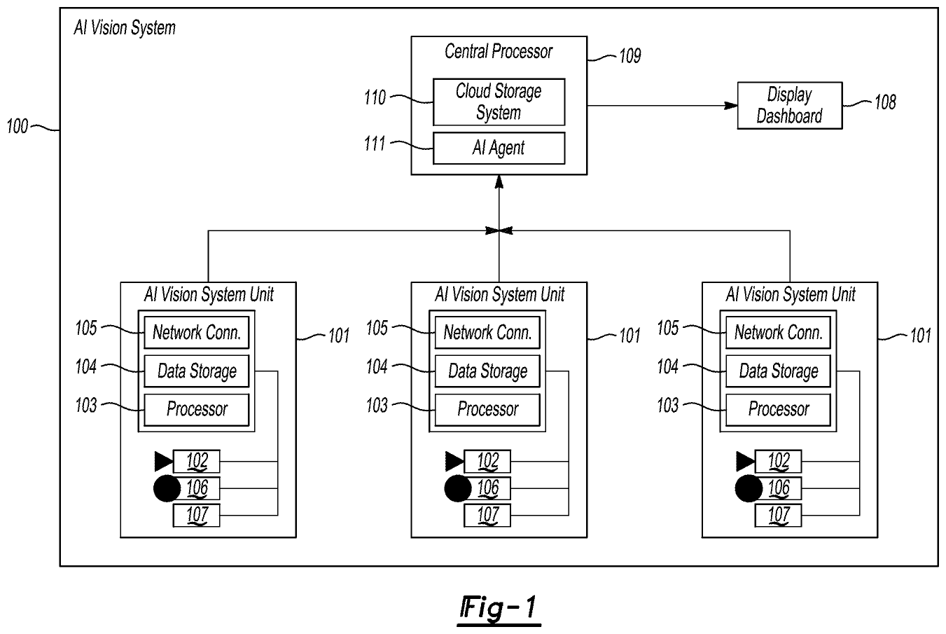

FIG. 1 is a block diagram illustrating an AVS 100. The AVS 100 includes one or more AVS units 101. Each AVS unit 101 includes a camera 102, a processor 103, a data storage device 104, and a network connectivity device 105. In some implementations, the data storage device 104 includes a memory storing executable instructions for execution by the processor 103. Each AVS unit 101 may optionally include a microphone 106 or a thermal camera 107.

The AVS units 101 are arranged along a manufacturing line to observe one or more operational stations. The operational stations may include a machining station, an assembly station, an inspection station, a transfer station, a storage station, or a transport station. The machining station performs material or part transformation operations. The assembly station combines components into assemblies. The inspection station evaluates parts or assemblies against defined criteria. The transfer station moves parts between stations. The storage station temporarily holds parts during processing. The transport station moves completed items for downstream handling.

The AVS 100 further includes a display dashboard 108. The display dashboard 108 presents system status information and operational notifications to a user. The AVS units 101 are communicatively coupled to a central processor 109. The central processor 109 includes a cloud storage system 110 and an AI agent 111. In some implementations, the central processor 109 is further communicatively coupled to manufacturing equipment through a control interface configured to transmit an operational command, a pause command, or a halt command to one or more stations, conveyors, robotic devices, or machine tools of the manufacturing line. In some implementations, the central processor 109 and the cloud storage system 110 collectively operate as a data aggregation system for receiving, storing, and aggregating event data generated by the AVS units 101.

In some implementations, each AVS unit 101 performs event recognition, temporal segmentation, and preliminary classification locally at the station prior to transmitting derived event data to the central processor 109. This distributed processing architecture reduces network bandwidth requirements and enables continued monitoring operation in the absence of continuous cloud connectivity.

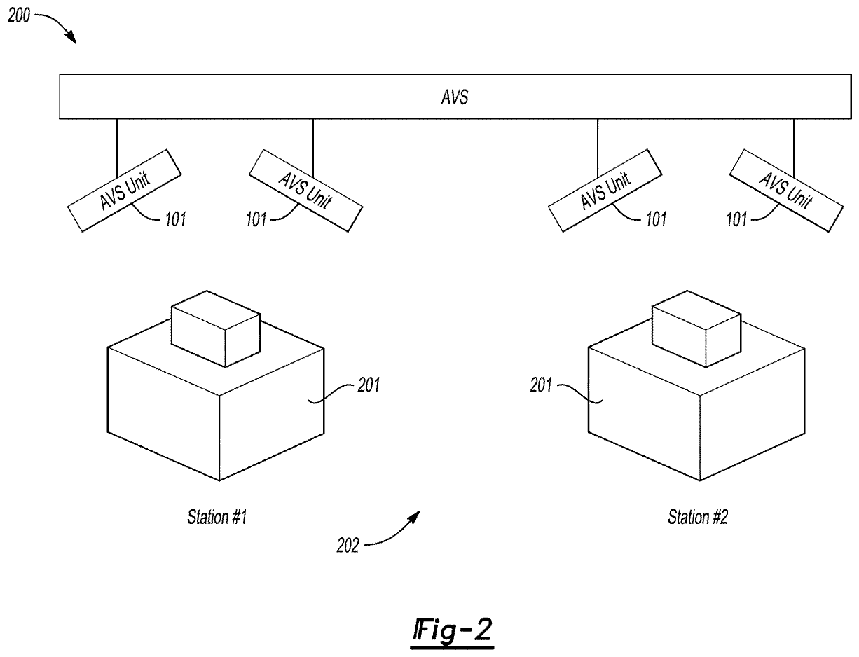

FIG. 2 illustrates a representative manufacturing line 200 monitored by the AVS 100. Each AVS unit 101 is physically mounted and positioned to observe one or more stations 201 along the manufacturing line 200. Each station 201 corresponds to a defined operational area within the manufacturing line 200.

Each AVS unit 101 operates in a plurality of phases. The plurality of phases includes a calibration phase, a monitoring phase, and an event evaluation phase. During the calibration phase, the AVS unit 101 establishes a reference operating context comprising expected event sequences, temporal relationships, and observable station characteristics.

During the monitoring phase, the processor 103 executes AI-based image processing and multi-modal language models. The AVS unit 101 observes ongoing activities at the station 201. The observed activities may include machining operations, assembly actions, inspections, transfers, storage actions, or transport actions. The AVS unit 101 processes captured data locally and transmits derived data to the cloud storage system 110.

When operating conditions deviate from the established reference context, the AVS 100 initiates the event evaluation phase. During the event evaluation phase, the AI agent 111 analyzes the identified condition using fine-tuned multi-modal language models to determine contextual relevance and system response.

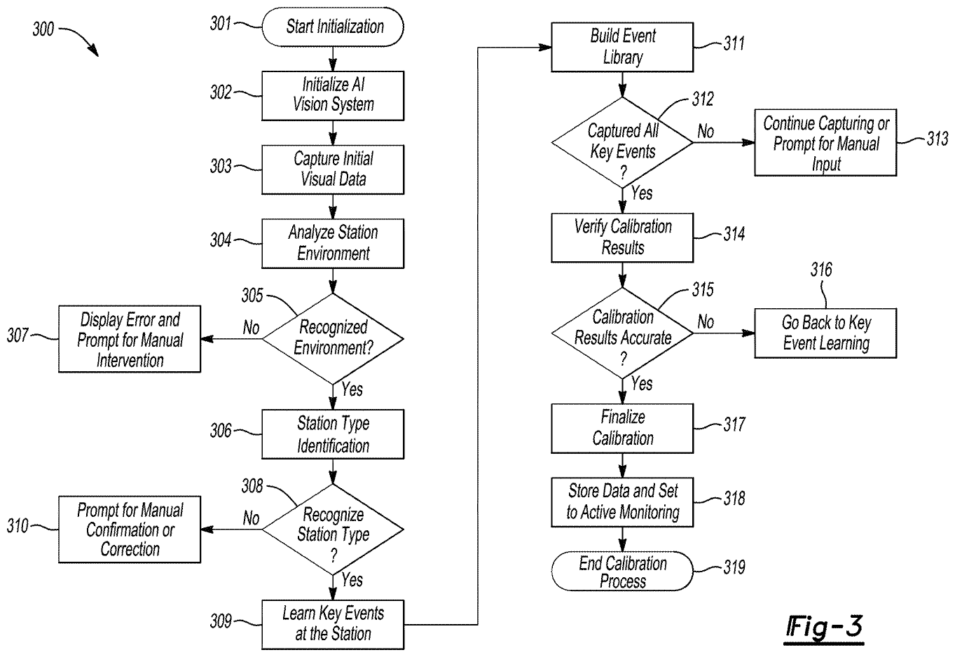

FIG. 3 illustrates a calibration phase 300 of the AVS 100. During the calibration phase 300, each AVS unit 101 determines the type of station it observes. The calibration phase 300 begins with a start initialization step 301. The AVS 100 then performs an initialization step 302. During the initialization step 302, hardware components and software components of the AVS 100 are prepared for operation. The AVS unit 101 establishes network communication and confirms connectivity with the cloud storage system 110.

After the initialization step 302, the AVS 100 captures initial visual data 303 from the observed environment. The initial visual data includes images or video of the station. The AVS 100 analyzes the initial visual data to evaluate the station environment 304. The AVS 100 then determines whether the station environment is recognized 305. If the station environment is recognized, the AVS 100 proceeds to a station type identification step 306. If the station environment is not recognized, the AVS 100 presents a notification through the display dashboard 108 and requests manual assistance 307.

During the station type identification step 306, the AVS 100 evaluates observable features within the field of view. The observable features include machinery, tools, and recurring objects. The AVS 100 then determines whether the station type is recognized 308. If the station type is recognized, the AVS 100 proceeds to a key event learning step 309. If the station type is not recognized, the AVS 100 requests manual confirmation or correction 310. The manual input establishes a correct station classification.

During the key event learning step 309, the AVS 100 identifies operational activities associated with the station type. The AVS 100 builds an event library 311 based on the identified activities. The AVS 100 monitors the station to determine whether all key events have been captured 312. If additional data is required, the AVS 100 continues capturing information or awaits further operator input 313.

After the event library is established, the AVS 100 performs a calibration verification step 314. The AVS 100 captures representative operating cycles at the station. The captured data defines baseline timing patterns, motion sequences, and sound profiles. The AVS 100 evaluates whether the calibration results are acceptable 315. If the calibration results are not acceptable, the AVS 100 returns to the key event learning step 316.

The calibration phase 300 further includes validation of event logging functionality. Each logged entry includes a timestamp, an identifier of the AVS unit 101, and associated media data. The AVS 100 confirms that logged information is stored and retrievable through the cloud storage system 110.

When the calibration results are acceptable, the AVS 100 performs a finalization step 317. During the finalization step 317, calibration data is stored and the AVS 100 is set to an active monitoring state 318. The calibration phase 300 ends at an end calibration process step 319.

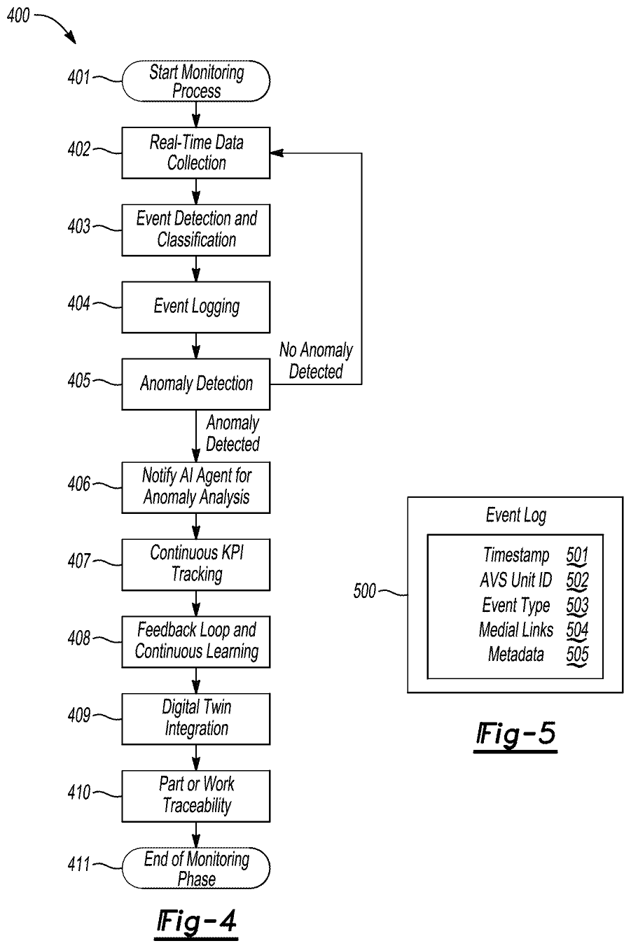

FIG. 4 illustrates a monitoring phase 400 of the AVS 100. The monitoring phase 400 begins after completion of the calibration phase 300. The monitoring phase 400 starts at a start monitoring phase step 401. The start monitoring phase step 401 initiates continuous observation of a manufacturing line by the AVS 100.

The monitoring phase 400 includes a real-time data collection step 402. During the real-time data collection step 402, each AVS unit 101 captures visual data from an assigned station. Each AVS unit 101 may also capture audio data. The captured data represents ongoing operational activity at the station.

The AVS 100 processes the captured data during an event detection and classification step 403. During the event detection and classification step 403, the AVS 100 identifies operational events based on reference patterns established during calibration. The identified events may include machine operation changes, part placement actions, tool interactions, inspection actions, or transfer activities. The AVS 100 assigns each identified event to a predefined event category.

After event detection and classification, the AVS 100 performs an event logging step 404. During the event logging step 404, the AVS 100 generates a log entry for each identified event. Each log entry includes a timestamp and an identifier of the AVS unit 101. The AVS 100 transmits the event log data to the cloud storage system 110 for centralized access and analysis.

FIG. 4 illustrates a flowchart that represents the monitoring phase 400 of the AVS 100. This phase supports the goal of delivering a cost-effective and intelligent factory monitoring solution. The process begins with the initiation of the monitoring phase 401, which marks the transition from calibration to continuous observation and data collection across the manufacturing line.

In the Real-Time Data Collection step 402, the AVS units 101 gather visual and optionally audio data in real time from their assigned stations. Each AVS unit 101 identifies and captures events relevant to each station type based on event patterns learned during calibration.

After collecting data, the AVS 100 performs Event Detection and Classification 403. The AVS 100 processes the incoming data to identify specific events such as machine start or stop cycles, part placements, tool changes, inspection results, and transfer activities. Each event is classified according to predefined templates and categorized to facilitate further analysis.

After this step, the AVS performs the Event Logging step 404. The AVS 100 generates an event log detailing identified events. The logs are periodically transmitted to a centralized cloud storage system 110 where they are accessible for system-level analysis.

After the event logging step 404, the AVS 100 performs a condition evaluation step 405. During the condition evaluation step 405, the AVS 100 compares logged events with expected operational patterns established during calibration. A deviation may include an absence of an expected event, an occurrence of an unexpected event, or a variation in timing or order relative to the expected operational patterns. If the logged events remain within an expected operating range, the AVS 100 continues the real-time data collection step 402.

If the condition evaluation step 405 identifies a deviation from the expected operating patterns, the AVS 100 initiates a notification step 406. During the notification step 406, the AVS 100 transmits event-related data to the AI agent 111. The AI agent 111 performs contextual analysis of the identified operating condition.

The monitoring phase 400 further includes a continuous KPI tracking step 407. During the continuous KPI tracking step 407, the AVS 100 calculates performance indicators based on logged events. The performance indicators include operational timing, throughput, utilization, and process consistency. The performance indicators are updated as new event data is logged.

The AVS 100 performs a feedback and continuous learning step 408. During the feedback and continuous learning step 408, the AVS 100 updates reference patterns and event models based on operational data and user input. The updates support refinement of event classification over time.

After the feedback and continuous learning step 408, the AVS 100 performs a digital twin integration step 409. During the digital twin integration step 409, logged operational data is associated with a virtual representation of the manufacturing line. The virtual representation reflects station structure, process flow, and current operating conditions.

The monitoring phase 400 further includes a part or work traceability step 410. During the part or work traceability step 410, the AVS 100 associates logged events with individual parts or work items as the parts or work items move through the manufacturing line.

The monitoring phase 400 concludes at an end monitoring phase step 411. After the end monitoring phase step 411, the AVS 100 remains in the monitoring phase 400 unless recalibration or reconfiguration is initiated.

FIG. 5 illustrates a representative event log 500 generated during the monitoring phase 400. Each event log 500 includes a timestamp 501, an identifier of the AVS unit 101 that captured the event 502, an event type 503, one or more media links 504, and metadata 505. The metadata 505 describes operational context associated with the event.

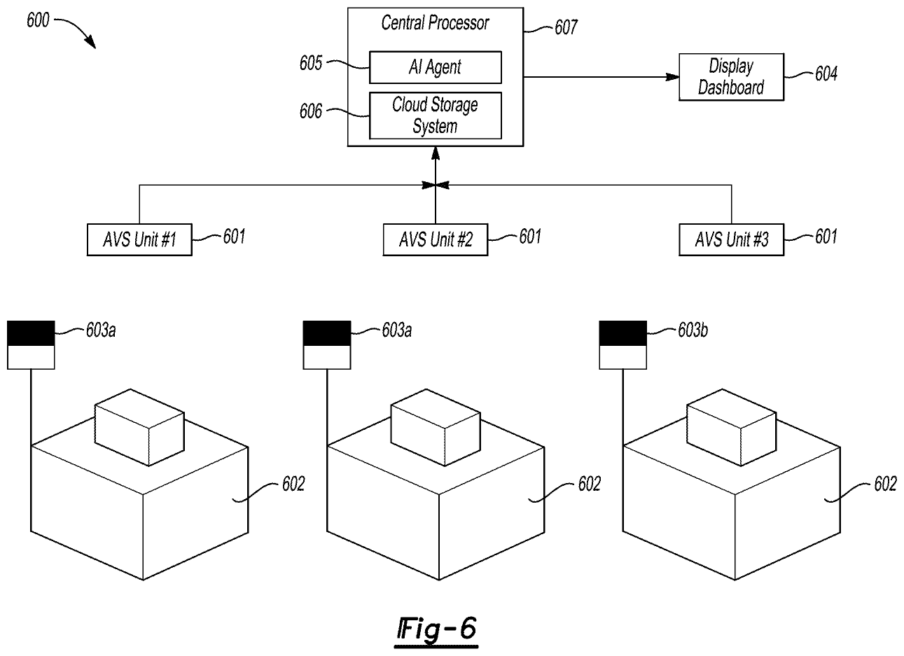

FIG. 6 illustrates a representative workflow 600 executed during the monitoring phase 400. The workflow 600 includes a plurality of AVS units 601 positioned to observe a plurality of stations 602. Each AVS unit 601 captures operational events at a corresponding station 602. The operational events include a station start event 603a and a station stop event 603b.

The AVS units 601 transmit the captured events to a cloud storage system 606. The cloud storage system 606 stores event data received from the AVS units 601. The stored event data is used to update a digital twin representation and to calculate performance indicators.

A display dashboard 604 presents operational information derived from the stored event data. The display dashboard 604 reflects current operating status and aggregated performance information. The system generates historical summaries based on stored event data.

When operating conditions deviate from expected patterns, the system provides event-related data to an AI agent 605. The AI agent 605 performs contextual analysis of the event-related data. The contextual analysis supports system-level interpretation of observed operating conditions.

In various implementations, processing associated with the AVS units 601 may be distributed across edge devices and centralized computing resources. For example, certain operations such as monitoring, event segmentation, and preliminary anomaly detection may be performed locally by the processors within the AVS units 601. In some implementations, calibration processes and higher-level anomaly analysis may be performed using centralized computing resources, such as the cloud storage system 606 or other centralized processing systems. Artificial intelligence models used for event recognition, anomaly detection, or contextual analysis may be executed locally at the AVS units 601, within centralized computing resources, or in a hybrid configuration in which portions of the analysis are performed at the edge and portions are performed centrally. In some implementations, the AVS units 601 may operate as self-contained monitoring devices capable of performing calibration, monitoring, and anomaly detection locally. In other implementations, processing operations may be performed substantially within centralized computing resources. Accordingly, the system architecture supports deployment in which monitoring, model execution, anomaly detection, and analysis operations may occur at the edge, in centralized computing resources, or in a combination of both.

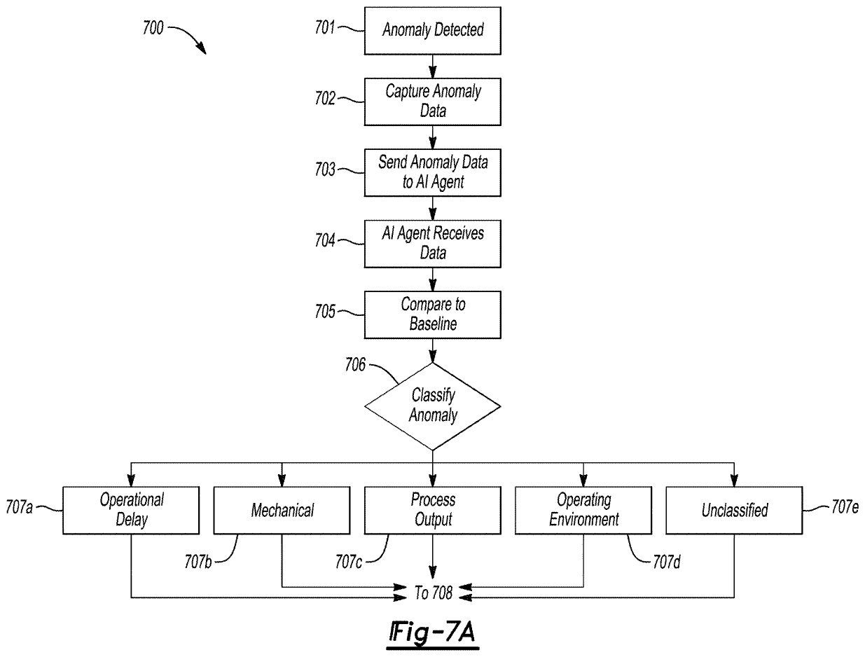

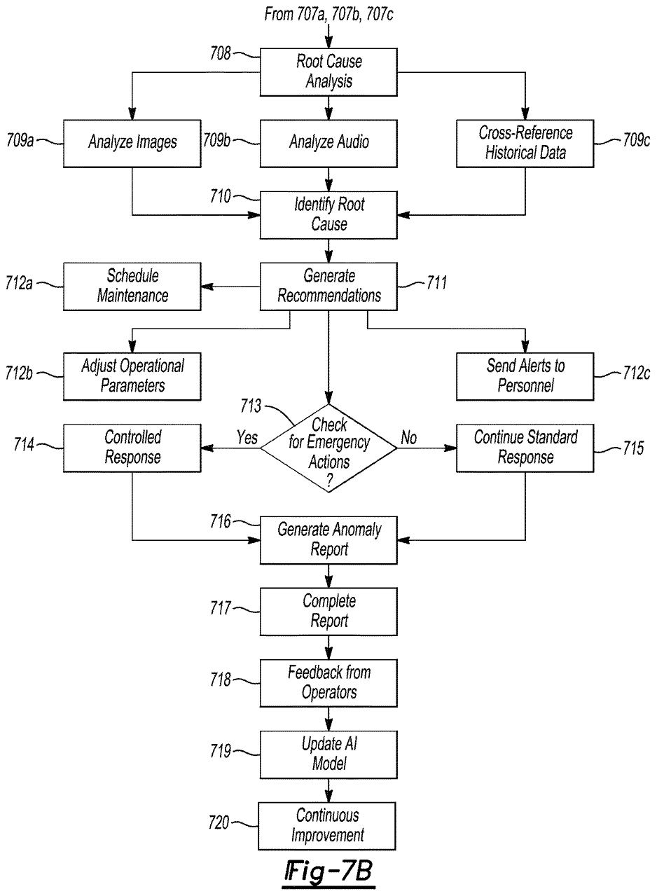

FIGS. 7A and 7B illustrate an event analysis phase 700 executed by the AVS 100. The event analysis phase 700 begins when a deviation from an expected operating pattern is identified 701. The deviation is identified by an AVS unit 101 during the monitoring phase 400.

After the deviation is identified 701, the AVS 100 performs a data capture step 702. During the data capture step 702, the AVS 100 collects event-related data. The event-related data includes time-referenced images, video segments, and optional audio data. The event-related data further includes contextual metadata associated with the observed station.

The AVS 100 transmits the event-related data to the AI agent 111 during a data transmission step 703. The AI agent 111 receives the event-related data during a data reception step 704. The AI agent 111 compares the received data to baseline operating patterns during a comparison step 705.

After the comparison step 705, the AI agent 111 performs an event classification step 706. During the event classification step 706, the AI agent 111 assigns the deviation to one of a plurality of event categories. The event categories include an operational delay category 707a, a mechanical condition category 707b, a process output condition category 707c, an operating environment condition category 707d, or an unclassified condition category 707e.

Following the event classification step 706, the AI agent 111 performs a root cause evaluation step 708. During the root cause evaluation step 708, the AI agent 111 analyzes image data 709a, analyzes audio data 709b, and cross-references historical operating data 709c. The analysis supports identification of contributing operating factors.

Based on the root cause evaluation step 708, the AI agent 111 identifies a primary contributing factor during an identification step 710. The AI agent 111 then generates one or more response recommendations during a recommendation generation step 711.

The response recommendations may include a maintenance scheduling action 712a, an operating parameter adjustment action 712b, or a personnel notification action 712c. The AI agent 111 evaluates whether an immediate response procedure is required during a response determination step 713.

If the response determination step 713 indicates that an immediate response procedure is required, the AI agent 111 initiates a controlled response step 714. The controlled response step 714 may include transmission of a control signal through a control interface to pause or stop operation of one or more portions of the manufacturing line. If the response determination step 713 indicates that an immediate response procedure is not required, the AI agent 111 continues a standard response step 715.

After execution of the controlled response step 714 or the standard response step 715, the AI agent 111 generates an event report during a report generation step 716. The AI agent 111 compiles the event report during a report compilation step 717.

The AVS 100 receives operator input during a feedback reception step 718 after completion of the report compilation step 717. The operator input is provided by human operators or maintenance personnel who review the event report. The operator input may include corrections, confirmations, or additional observations.

The AI agent 111 updates one or more analytical models during a model update step 719 based on the received operator input. The model update step 719 may occur according to a predefined schedule or in response to accumulated feedback. The event analysis phase 700 concludes with a continuous refinement step 720.

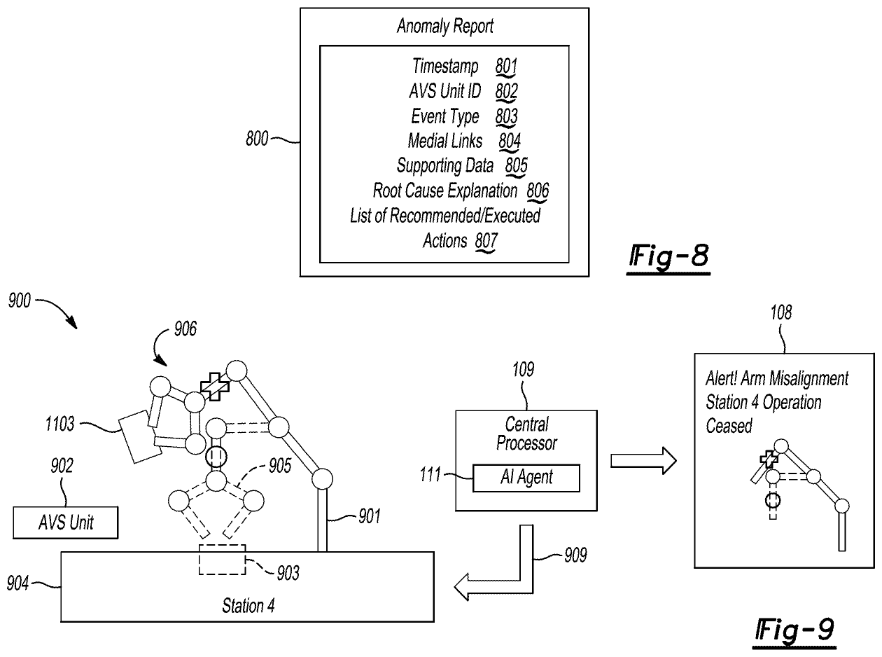

FIG. 8 illustrates a representative event report 800 generated during the event analysis phase 700. The event report 800 includes a timestamp 801 that identifies when the event occurred. The event report 800 further includes an identifier of an AVS unit 802 that captured the event.

The event report 800 includes an event type 803 associated with the captured event. The event report 800 further includes one or more media links 804. The media links 804 reference associated image data, video data, or audio data.

The event report 800 further includes supporting data 805. The supporting data 805 provides contextual information related to operating conditions at the time of the event. The event report 800 further includes a root cause explanation 806 generated by the AI agent 111.

The event report 800 also includes a list of actions 807. The list of actions 807 identifies one or more actions recommended by the system or executed in response to the event.

FIG. 9 illustrates a representative operating scenario 900 processed during the event analysis phase 700. The operating scenario 900 occurs at a station that includes a robotic arm 901. An AVS unit 902 is positioned to observe operation of the robotic arm 901.

During normal operation, the AVS unit 902 expects a part 903 to appear on a conveyor belt 904 after completion of a movement sequence by the robotic arm 901. The movement sequence is expected to place the part 903 at a defined position 905.

In the illustrated scenario, the part 903 is not detected at the expected position. The AVS 100 identifies a deviation from an expected operating pattern. Visual data captured by the AVS unit 902 indicates an alignment variation in the robotic arm 901 during motion 906.

The AVS unit 902 transmits the captured data to the central processor 109. The AI agent 111 analyzes the captured data and determines that the deviation is associated with the alignment variation. The AI agent 111 generates event-related information and provides the information to a display dashboard 108 for operator review.

In some operating conditions, the system may initiate a controlled response 909 such as stopping the conveyor belt 904 based on the determined operating condition.

The illustrated operating scenario demonstrates coordinated operation of event identification, contextual analysis, and response determination within the AVS 100. The AVS 100 classifies observed operating conditions, evaluates contributing factors, and supports generation of response actions through the AI agent 111.

The event analysis phase 700 further supports adaptive model updates based on observed operating conditions and operator input. The structured processing logic illustrated in FIGS. 3 and 7A-7B enables recurring operating conditions to be evaluated and incorporated into subsequent system behavior across a manufacturing environment.

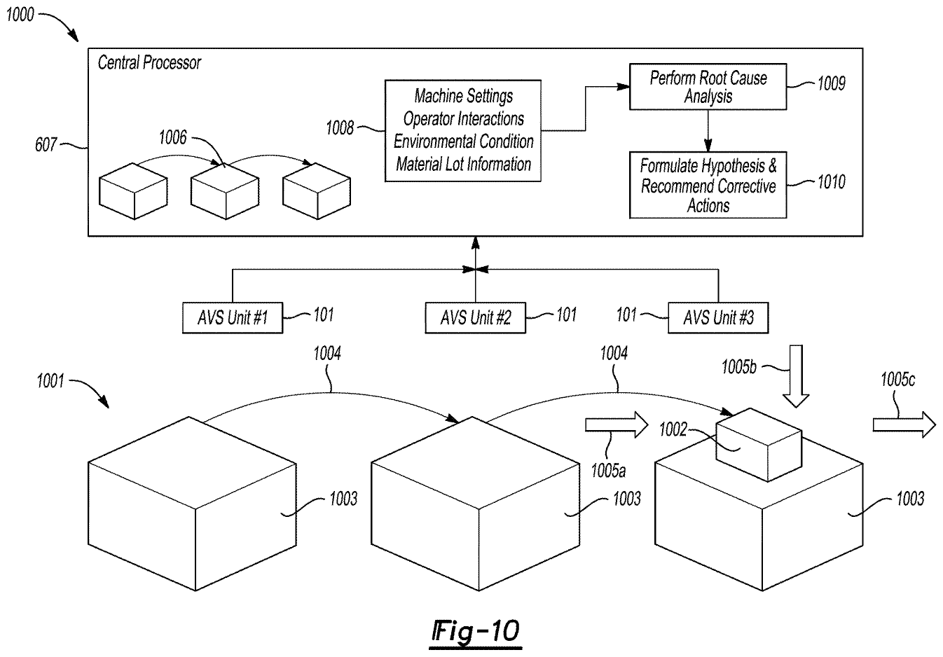

FIG. 10 illustrates a traceability operation 1000 supported by the AVS 100. The traceability operation 1000 tracks individual workpieces as the workpieces move through a manufacturing process. The traceability operation 1000 operates in conjunction with the monitoring phase 400 and the event analysis phase 700.

The traceability operation 1000 begins with an object identification step 1001. During the object identification step 1001, an AVS unit 101 identifies a workpiece 1002 entering a station 1003. The AVS unit 101 assigns a time reference to the workpiece 1002.

As the workpiece 1002 progresses through the station 1003, the AVS unit 101 records operational events. The operational events include a workpiece entry event 1005a, a processing event 1005b, and a workpiece exit event 1005c. Each operational event is recorded with associated metadata.

The workpiece 1002 moves between stations 1003 along a manufacturing line 1004. A central processor 107 aggregates recorded event data associated with the workpiece 1002. The central processor 107 constructs a process path 1006 that represents a sequence of stations visited by the workpiece 1002.

When an operating condition associated with the workpiece 1002 is identified at a downstream station, the central processor 107 retrieves previously recorded data associated with the workpiece 1002. The retrieved data is collected from one or more upstream stations 1008. The retrieved data includes machine settings, operator interactions, environmental conditions, and material lot information.

The AI agent 111 analyzes the retrieved data during a causal evaluation step 1009. The causal evaluation step 1009 compares the retrieved data with previously observed operating patterns. Based on the comparison, the AI agent 111 generates one or more response recommendations during a recommendation formulation step 1010.

The traceability operation 1000 supports correlation of operating conditions with specific stations, process parameters, and workpiece histories. The traceability operation 1000 further supports review of process behavior across multiple stations.

By associating time-referenced event data with individual workpieces, the AVS 100 maintains continuous visibility of workpiece movement across the manufacturing process. The traceability operation 1000 supports data-driven evaluation of process behavior across a manufacturing environment.

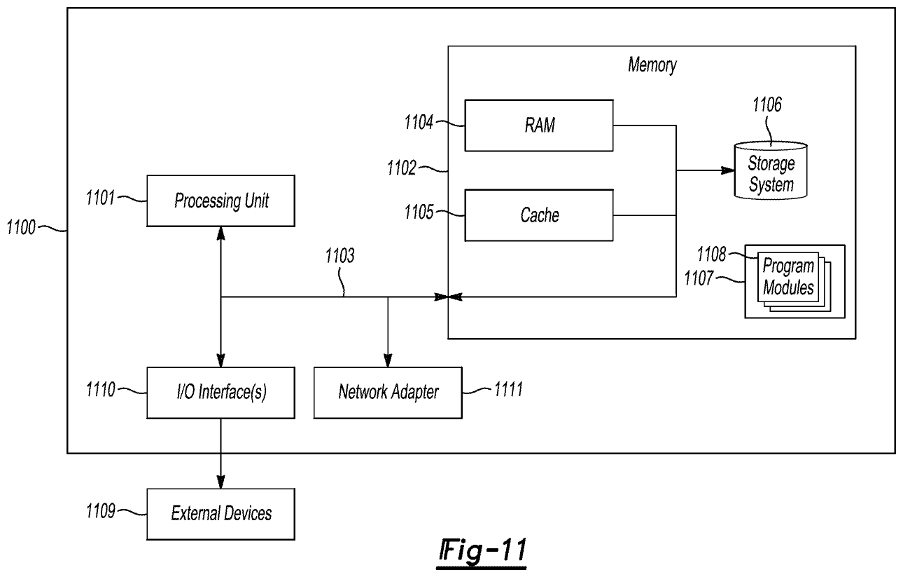

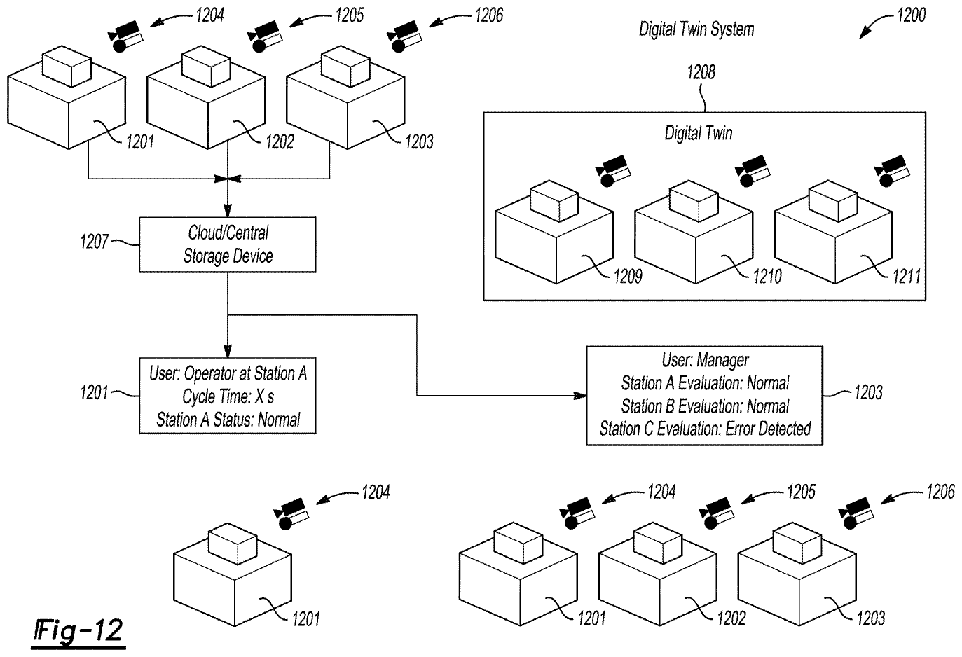

FIG. 11 illustrates a representative computing device 1100. The computing device 1100 may be used to implement one or more functions described herein. The computing device 1100 may represent the central processor 109 or the cloud storage system 110. The computing device 1100 executes computer-readable instructions stored in memory.

The computing device 1100 includes a processing unit 1101, a system memory 1102, and a bus 1103. The bus 1103 couples the processing unit 1101 to the system memory 1102 and other components of the computing device 1100.

The bus 1103 represents one or more data communication structures. The data communication structures may include a memory bus, a peripheral bus, or a processor bus. The bus 1103 supports data transfer between components of the computing device 1100.

The processing unit 1101 executes program instructions stored in the system memory 1102. The program instructions implement one or more operations described in this disclosure. The processing unit 1101 may include one processor or a plurality of processors.

The computing device 1100 includes computer-readable media. The computer-readable media includes volatile media and non-volatile media. The computer-readable media includes removable media and non-removable media.

The system memory 1102 includes random access memory 1104 and cache memory 1105. The computing device 1100 further includes a storage system 1106. The storage system 1106 stores program data and operational data. The system memory 1102 stores one or more program products. Each program product includes program modules configured to perform operations described herein.

The system memory 1102 stores a program utility 1107. The program utility 1107 includes one or more program modules 1108. The program modules 1108 include executable instructions and associated data.

The computing device 1100 communicates with one or more external devices 1109 through one or more input/output interfaces 1110. The external devices 1109 include user interface devices or peripheral devices.

The computing device 1100 communicates with one or more networks through a network adapter 1111. The network adapter 1111 is coupled to the bus 1103. The network adapter 1111 supports data exchange with remote computing systems.

The AVS 100 may include one or more sensors. The sensors include cameras, acoustic sensors, proximity sensors, inertial measurement unit sensors, positioning sensors, RADAR sensors, and LIDAR sensors. The selected sensor type depends on an operational station monitored by an AVS unit 101. In some implementations, non-visual sensors are used to supplement visual observations at stations where line-of-sight visibility is limited or where spatial measurement is required.

FIG. 12 illustrates a representative digital twin system 1200 for a manufacturing environment. The digital twin system 1200 includes a plurality of manufacturing stations 1201, 1202, 1203.

The digital twin system 1200 further includes a plurality of vision and microphone units 1204, 1205, 1206. The vision and microphone unit 1204 is positioned to sense the manufacturing station 1201. The vision and microphone unit 1205 is positioned to sense the manufacturing station 1202. The vision and microphone unit 1206 is positioned to sense the manufacturing station 1203. Each vision and microphone unit 1204, 1205, 1206 captures station-related visual and audio data that represents operation occurring at the corresponding manufacturing station 1201, 1202, 1203. Each vision and microphone unit 1204, 1205, 1206 generates station-related event data based on the captured visual and audio data. The station-related event data may include time-referenced event records and associated media.

The digital twin system 1200 further includes a cloud/central storage device 1207. The cloud/central storage device 1207 is communicatively coupled to the vision and microphone units 1204, 1205, 1206. The cloud/central storage device 1207 receives the station-related event data generated by the vision and microphone units 1204, 1205, 1206. The cloud/central storage device 1207 stores the received station-related event data for later retrieval. The cloud/central storage device 1207 also supports aggregation of station-related event data across the manufacturing stations 1201, 1202, 1203.

The digital twin system 1200 further includes a digital twin 1208. The digital twin 1208 is stored in, or accessible through, the cloud/central storage device 1207. The digital twin 1208 represents a virtual view of the manufacturing environment based on the station-related event data received from the vision and microphone units 1204, 1205, 1206. The digital twin 1208 includes a plurality of virtual station representations 1209, 1210, 1211. The virtual station representation 1209 corresponds to the manufacturing station 1201. The virtual station representation 1210 corresponds to the manufacturing station 1202. The virtual station representation 1211 corresponds to the manufacturing station 1203. The digital twin 1208 is updated based on aggregated station-related event data stored in the cloud/central storage device 1207. The digital twin 1208 provides a consolidated view of station activity across multiple manufacturing stations.

The digital twin system 1200 further includes a first user interface 1212. The first user interface 1212 is configured for a first user role associated with station-level monitoring. The first user interface 1212 presents station-specific information associated with the manufacturing station 1201. The station-specific information may include a cycle time indicator and a station status indicator for the manufacturing station 1201. The first user interface 1212 receives data from the cloud/central storage device 1207. The first user interface 1212 presents the station-specific information based on the station-related event data stored in the cloud/central storage device 1207 and reflected in the digital twin 1208.

The digital twin system 1200 further includes a second user interface 1213. The second user interface 1213 is configured for a second user role associated with multi-station review. The second user interface 1213 presents aggregated station evaluation information associated with the manufacturing station 1201, the manufacturing station 1202, and the manufacturing station 1203. The aggregated station evaluation information may include a station evaluation status for each of the manufacturing station 1201, the manufacturing station 1202, and the manufacturing station 1203. The second user interface 1213 receives data from the cloud/central storage device 1207. The second user interface 1213 presents the aggregated station evaluation information based on the aggregated station-related event data stored in the cloud/central storage device 1207 and reflected in the digital twin 1208.

In operation, the vision and microphone units 1204, 1205, 1206 provide station-related event data to the cloud/central storage device 1207. The cloud/central storage device 1207 stores and aggregates the station-related event data across the manufacturing stations 1201, 1202, 1203. The digital twin 1208 is maintained based on the aggregated station-related event data. The first user interface 1212 and the second user interface 1213 present role-specific information derived from the aggregated station-related event data and the digital twin 1208.

The disclosed subject matter may be implemented as a system, a method, or a computer program product. The computer program product includes a computer-readable storage medium storing program instructions. The program instructions cause a processor to perform operations described herein.

A computer-readable storage medium is a tangible device that stores instructions for use by a processing device. The computer-readable storage medium includes electronic, magnetic, optical, electromagnetic, or semiconductor-based storage media, or combinations thereof. The computer-readable storage medium does not include transitory signals.

A non-transitory computer-readable storage medium includes one or more physical storage devices. The physical storage devices store program instructions in electronic, magnetic, optical, or semiconductor form.

Computer-readable program instructions may be transmitted to a computing device through a network. The network includes wired or wireless communication paths. A network interface receives the program instructions and provides the program instructions for execution or storage.

The flowcharts and block diagrams illustrate representative architectures and operations. Each block represents a functional unit or a portion of executable instructions. The blocks may be executed in different orders. The blocks may be implemented using software, hardware, or a combination thereof.

Each functional block may be implemented by computer program instructions executed by a processor. The computer program instructions cause the processor to perform operations associated with the functional block.

Processes described herein may be executed continuously or intermittently. The processes may be executed by one or more computing devices. Individual process steps may be executed by different computing devices.

The described embodiments are provided for illustration. The described embodiments do not limit the scope of the disclosure. Modifications and variations may be implemented without departing from the scope of the appended claims.

As used herein, a module or component represents software, firmware, hardware, or a combination thereof. In a software implementation, a module includes program code executed by a processor.

Program code may be written in assembly language or higher-level programming languages. The program code may be translated into machine-readable form for execution.

Computer-executable instructions may be stored in a computer-readable storage medium. Execution of the instructions causes a computing device to perform defined operations.

The order of described operations is not fixed unless explicitly stated. Operations may be performed in parallel or in a different sequence. Figures may omit interactions for clarity.

Any disclosed method may be implemented as computer-executable instructions stored on a computer-readable storage medium. The computer-readable storage medium includes tangible storage media accessible to a computing device.

Variations, substitutions, and equivalent arrangements may be implemented within the scope of the appended claims. The described embodiments illustrate representative implementations.

The terminology used herein is descriptive. The terminology does not limit the scope of the disclosure.

What is claimed is:

1. A manufacturing monitoring system, comprising:
one or more vision units, each vision unit including a camera, a local processor, a data storage device, and a network interface, wherein each vision unit is deployable at a manufacturing station and is configured to capture visual data representing operation of the manufacturing station;
a central processing system communicatively coupled to the one or more vision units and including at least one processor and a non-transitory storage medium storing executable instructions; and
an artificial intelligence agent executed by the central processing system, wherein the manufacturing monitoring system is configured such that the one or more vision units generate time-referenced event records associated with observed station operations, the event records including media data and contextual metadata, the central processing system aggregates the event records received from the one or more vision units and maintains an operational representation of a manufacturing line, the artificial intelligence agent receives event-related data from the central processing system and applies a learned reference context to the received event-related data, and the manufacturing monitoring system provides event-associated information to a user interface for review or action.

2. The manufacturing monitoring system of claim 1, wherein the one or more vision units are configured to establish a reference operating context for the manufacturing station during a calibration phase executed locally at the one or more vision units.

3. The manufacturing monitoring system of claim 1, wherein the one or more vision units are configured to generate the time-referenced event records based on segmented operational activity observed at the manufacturing station.

4. The manufacturing monitoring system of claim 1, wherein the one or more vision units are configured to transmit derived event data to the central processing system independently of continuous transmission of raw visual data.

5. The manufacturing monitoring system of claim 1, wherein each vision unit further includes at least one additional sensor selected from an acoustic sensor, a proximity sensor, a vibration sensor, a temperature sensor, a thermal sensor, a current sensor, a RADAR sensor, or a LIDAR sensor.

6. The manufacturing monitoring system of claim 1, wherein each time-referenced event record includes a timestamp, an identifier of the vision unit, and metadata describing an operating context of the manufacturing station.

7. The manufacturing monitoring system of claim 1, wherein the operational representation of the manufacturing line includes a virtual representation reflecting relationships between manufacturing stations and event sequences.

8. The manufacturing monitoring system of claim 7, wherein the virtual representation is updated based on aggregation of event records received from multiple vision units.

9. The manufacturing monitoring system of claim 1, wherein the artificial intelligence agent is implemented using one or more trained multi-modal models executed by the central processing system.

10. The manufacturing monitoring system of claim 1, wherein the artificial intelligence agent is configured to associate event records with individual workpieces as the workpieces move between manufacturing stations.

11. The manufacturing monitoring system of claim 10, wherein the central processing system maintains a chronological process path for each associated workpiece based on the event records.

12. The manufacturing monitoring system of claim 1, wherein the central processing system is implemented using a cloud-based computing environment.

13. A monitoring system for a manufacturing environment, comprising:
one or more vision units positionable adjacent to respective manufacturing stations of a manufacturing line, each vision unit including a camera, a processor, and a memory, wherein the memory of each vision unit stores executable instructions that, when executed by the processor of the vision unit, cause the vision unit to generate time-referenced event data representing operational activity occurring at the respective manufacturing station based on visual data captured by the camera;
a data aggregation system communicatively coupled to the one or more vision units and including at least one processor and a memory storing executable instructions, wherein the executable instructions of the data aggregation system, when executed by the at least one processor, cause the data aggregation system to receive the time-referenced event data from the one or more vision units, evaluate the time-referenced event data relative to a reference operational context associated with the manufacturing line, and provide station-related operational information to a user interface.

14. The monitoring system of claim 13, wherein the executable instructions stored in the memory of each vision unit cause the processor of the vision unit to generate the time-referenced event data based on segmented activity identified within the visual data captured by the camera.

15. The monitoring system of claim 13, wherein the executable instructions of the data aggregation system cause the at least one processor to apply one or more trained multi-modal models to the time-referenced event data to generate the station-related operational information.

16. The monitoring system of claim 13, wherein the executable instructions of the data aggregation system cause the at least one processor to maintain a digital representation of the manufacturing line based on the time-referenced event data received from the one or more vision units.

17. A manufacturing line control system, comprising:
one or more vision units positioned to observe respective stations of a manufacturing line, each vision unit including a camera, a processor, and a memory storing instructions that, when executed by the processor, cause the vision unit to produce time-referenced event data representing activity occurring at the respective station based on visual data captured by the camera; and
a control processor communicatively coupled to the one or more vision units, wherein the control processor is configured to receive the time-referenced event data from the one or more vision units, compare the received event data with a stored reference operating context for the manufacturing line, and transmit a halt command to equipment of the manufacturing line that stops operation of at least one station of the manufacturing line when the received event data deviates from the reference operating context.

18. The manufacturing line control system of claim 17, wherein the halt command causes a conveyor, robotic device, or machine tool of the manufacturing line to cease operation.

19. The manufacturing line control system of claim 17, wherein the reference operating context includes expected event sequences associated with operation of the stations.

20. The manufacturing line control system of claim 17, wherein the control processor generates the halt command when the received event data indicates absence of an expected operational event at one of the stations.
